(19) United States
(12) Patent Application Publication
(10) Pub. No.: US 2013/0151121 A1
(43) Pub. Date: Jun. 13, 2013

(54) METHOD OF CONTROLLING STARTING OF ENGINE FOR FFV

(71) Applicant: Jin Woo KIM, Gunpo-si (KR)

(72) Inventor: Jin Woo KIM, Gunpo-si (KR)

(73) Assignees: Kia Motors Corp., Seoul (KR); Hyundai Motor Company, Seoul (KR)

(21) Appl. No.: 13/536,613

(22) Filed: Jun. 28, 2012

(30) Foreign Application Priority Data
Dec. 8, 2011 (KR) 10-2011-0130853

(51) Int. Cl. F02D 41/26

(52) U.S. Cl. 701/104; 701/113

(57) ABSTRACT

In a fuel flexible vehicle (FFV) which is not equipped with an ethanol sensor, even in a state in which it is difficult to start an engine such as a situation in which the concentration of ethanol was not correctly determined or a situation in which a fuel with a different composition from the previously refueled fuel is pumped into the FFV, the starting of the engine can be ensured, which increases the reliability and commercial quality of the vehicle.

### CROSS-REFERENCE TO RELATED APPLICATIONS

The present application claims priority of Korean Patent Application Number 10-2011-0130853 filed Dec. 8, 2011, the entire contents of which application is incorporated herein for all purposes by this reference.

### BACKGROUND OF INVENTION

1. Field of Invention

The present invention relates to a method of controlling the starting of an engine for a flexible fuel vehicle (FFV), and more particularly to a technology for use in a vehicle which is not equipped with an ethanol sensor for measuring the concentration of ethanol in fuel, the technology enabling an engine to be started even in a state in which it is difficult to determine the concentration of ethanol and an engine of the vehicle is rendered difficult to start.

2. Description of Related Art

The sharp increase in global oil prices has been accompanied by a sharp increase in the demand for ethanol fuel which is relatively inexpensive compared to gasoline, especially in Brazil, China, East Asia, the United States, and other places. Moreover, research and development into technology related to FFVs which are capable of using ethanol as a fuel has been ongoing.

The stoichiometric air-fuel ratio of ethanol used in FFVs is 9:1, which means that a larger amount of ethanol is required compared to gasoline to obtain the same amount of energy. In vehicles, the ethanol concentration in fuel should be determined so that the quantity of fuel could be corrected in accordance with the determined ethanol concentration. In this way, an engine can smoothly run on any fuel, that is, any mixture of gasoline and ethanol, from pure gasoline up to 100% ethanol.

However, when the concentration of ethanol is incorrectly determined due to some kind of failure, or when an engine has been started in a state in which the concentration of ethanol in newly a refueled fuel, having a different composition from a fuel which has been put in a vehicle, has not yet been determined, it is sometimes difficult for the engine to start due to an incorrect quantify of fuel being supplied to the engine as a result of an incorrect determination having been made about the concentration of ethanol in the fuel.

In greater detail, the appropriate quantity of a fuel that is jetted into the engine to start the engine depends on the concentration of ethanol. If an excessive quantity or insufficient quantity of fuel is jetted into the engine, the fuel in a combustion chamber may fail to ignite, so that the engine cannot start.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for a method of controlling starting an engine for an FFV which is not equipped with an ethanol sensor, the method enabling the engine to be started even in a situation in which the determination of the concentration of ethanol is not incorrect or in a situation in which it is difficult for the engine to start for some reason such as fuel having a different composition from a previously refueled fuel being pumped into the FFV. Accordingly the method according to the invention increases the reliability and merchantable quality of vehicles.

Various aspects of the present invention provide for a method of controlling starting of an engine for an FFV, which includes: determining whether an engine needs to be started using an emergency starting method on the basis of the number of times an engine is attempted to be started; determining, when the determining of whether the engine needs to be started using an emergency starting method determines that the engine needs to be started using the emergency starting method, whether a current determined concentration of ethanol is equal to or greater than a predetermined concentration reference value; performing a concentration swinging operation which includes starting type A, which occurs when the determining of whether the current determined concentration of ethanol is equal to or greater than the predetermined concentration reference value determines that the current determined concentration of ethanol is equal to or greater than the predetermined concentration reference value, in which the engine is started by using a value within a concentration range which is below the predetermined concentration reference value as a current concentration of ethanol, and starting type B, which occurs when the determining of whether the current determined concentration of ethanol is equal to or greater than the predetermined concentration reference value determines that the current determined concentration of ethanol is less than the predetermined concentration reference value, in which the engine is started by using a value within a concentration range which is above the predetermined reference value as the concentration of ethanol; and determining whether the starting of the engine has succeeded.

According to other aspects of the invention, there is provided a method of controlling starting of an engine for an FFV which includes: determining whether a cumulative number of cranking operations which have ended up with an unsuccessful starting of the engine is equal to or greater than a predetermined number; comparing, when all attempts to start the engine have ended in failure and the cumulative number of cranking operations is equal to or greater than the predetermined number, a current determined ethanol concentration with a predetermined concentration reference value; setting, when the current determined ethanol concentration is greater than the predetermined concentration reference value, a concentration of ethanol to a value less than the predetermined concentration reference value and trying to start the engine using the value that has been set; and setting, when the current determined ethanol concentration is less than the predetermined concentration reference value, the concentration of ethanol to a value greater than the predetermined concentration reference value and trying to start the engine using the value that has been set.

According to various aspects of the present invention, in an FFV which is not equipped with an ethanol sensor, even when it is difficult for an engine to start because of any trouble such as a situation in which a correct concentration of ethanol cannot be determined or a situation in which refueling is done using a fuel having a different composition, the starting of the engine is ensured and thus the reliability and merchantable quality of the vehicle can be increased.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a flow chart illustrating an exemplary method of controlling starting of an engine for an FFV according to the present invention.

FIG. 2 is a graph describing an exemplary situation in which an engine is started according to the present invention.

FIG. 3 is a flow chart illustrating an exemplary method of controlling the starting of an engine for an FFV according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

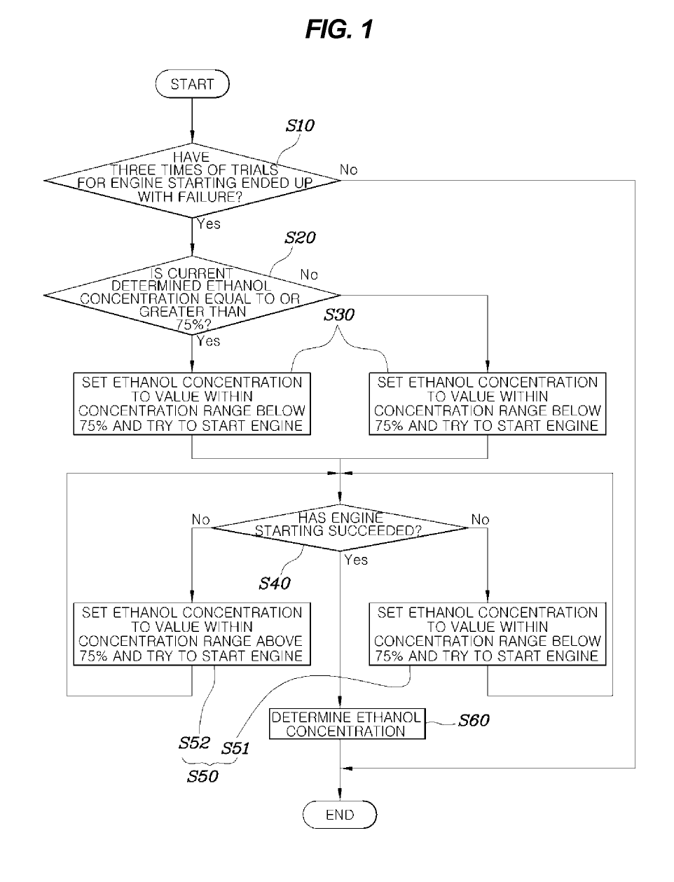

Referring to FIG. 1, a method of controlling starting of an engine for an FFV according to an embodiment of the invention includes an emergency situation determining step (S10) of determining whether an engine needs to be started using an emergency starting method on the basis of the number of times the engine is attempted to be started, a reference determining step (S20) of determining, when the emergency situation determining step determines that the engine needs to be started using the emergency starting method, whether a current determined ethanol concentration is equal to or greater than a predetermined concentration reference value, a concentration swinging step (S30) of starting, when the reference determining step determines that the current determined ethanol concentration is equal to or greater than the predetermined concentration reference value, the engine using a value within a concentration range which is less than the predetermined concentration reference value, but starting, when the reference determining step determines that the current determined ethanol concentration is less than the predetermined concentration reference value, the engine using a value in a concentration range which is above the predetermined concentration reference value, and a starting success determining step (S40) of determining whether the starting of the engine has succeeded after performing the concentration swinging step (S30).

That is, it is determined whether a cumulative number of cranking operations, which have concluded in the unsuccessful starting of the engine, has reached or exceeded a predetermined reference number. When the cumulative number of cranking operations that have been unsuccessful at starting the engine is equal to or greater than the predetermined reference number, the engine stalling is considered to be attributable to the current determined ethanol concentration being incorrect. Then, the current determined ethanol concentration is compared with a predetermined concentration reference value. When the comparison shows that the current determined ethanol concentration is greater than the predetermined concentration reference value, the current determined ethanol concentration is manually changed and set to a value less than the predetermined concentration reference value so that the engine can be started with the changed value. Otherwise, the current determined ethanol concentration is manually changed and set to a value greater than the predetermined reference value so that the engine can be started with this changed value. In this way, even when a currently determined ethanol concentration is an incorrect concentration or a current ethanol concentration has not yet been determined, the current ethanol concentration can be estimated and the estimated concentration value can be applied, so that the engine can be started.

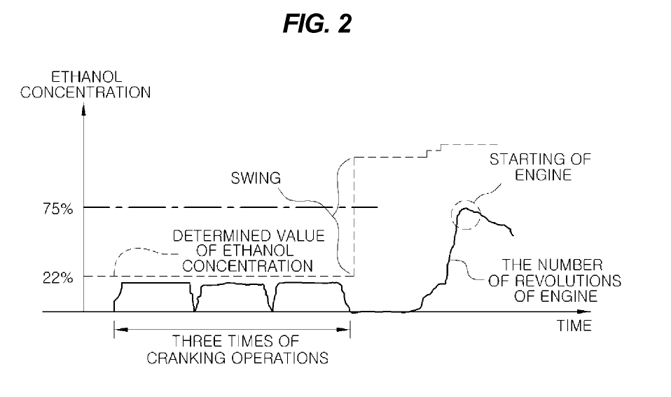

As illustrated in FIG. 2, when the currently determined ethanol concentration is 22% and the cranking has been made three times, the number of revolutions increases at an early stage of each cranking but drops thereafter, resulting in the unsuccessful starting of the engine. This event is considered to be attributable to the fact that the determined ethanol concentration is incorrect. Therefore, the currently determined ethanol concentration is compared with a concentration reference value of 75%. Since the current determined value of 22% is less than the concentration reference value of 75%, the fourth time of cranking the engine and the subsequent cranking operations are carried out after changing the value of the current ethanol concentration to a value within a concentration range greater than 75%. FIG. 2 illustrates the state in which the engine is successfully started in the way described above, and thus the number of revolutions of the engine has increased.

Here, the reason why the operation of manually changing the value of the ethanol concentration to a larger value when the current determined value of the ethanol concentration is less than the concentration reference value or vice versa is based on the following reason. That is, when the three cranking operations of the engine have been carried out using the current determined value of the ethanol concentration to start the engine, if the actual ethanol concentration is close to the currently determined ethanol concentration, the engine would be successfully started. However, because the attempts at starting the engine have not been successful, there is a high probability that the currently determined value of the ethanol concentration deviates a lot from the actual ethanol concentration. Accordingly, a value which is far from the currently determined ethanol concentration is selected to be used in the next attempt to start the engine.

Accordingly, the predetermined concentration reference value may be set to a value which is very likely to be an actual ethanol concentration when the actual ethanol concentration is tracked using a concentration swinging method. Therefore, this value is appropriately set by carrying out experimentation a plurality of times.

In the present embodiment, when the starting success determining step (S40) determines that the starting of the engine has been unsuccessful, a concentration tracking step (S50) is repeatedly performed in which the value of the ethanol concentration is changed to a different value within the concentration range defined in the concentration swinging step (S30) and then an attempt to start the engine is made. The concentration tracking step (S50) includes an upper value tracking step (S51) of setting the value of the ethanol concentration to a value within a concentration range which is above the concentration reference value and a lower value tracking step (S52) of setting the value of the ethanol concentration to a value within a concentration range which is less than the concentration reference value.

That is, since the engine cranking operation must be performed several times using the currently determined value of ethanol concentration and this operation has ended in failure to start the engine, values which are within the range on the side opposite to the current determined value with respect to the concentration reference value are sequentially used as candidate values of the current ethanol concentration and the engine cranking operation is further repeatedly performed to start the engine.

In the lower value tracking step (S52), control may be performed such that the value of the ethanol concentration is changed (that is, decreased) by a relatively great amount once, and after that, the value is gradually increased by a relatively small amount.

The lower value tracking step (S52) refers to a state in which the engine cranking operations are performed several times using the current determined value of the ethanol concentration being greater than the concentration reference value and then the value is changed to a value within a concentration range lower than the concentration reference value. In this state, owing to the failed attempts to start the engine having been repeated, quite large quantity of fuel may accumulate inside the engine. In the lower value tracking step (S52), such accumulated fuel is consumed.

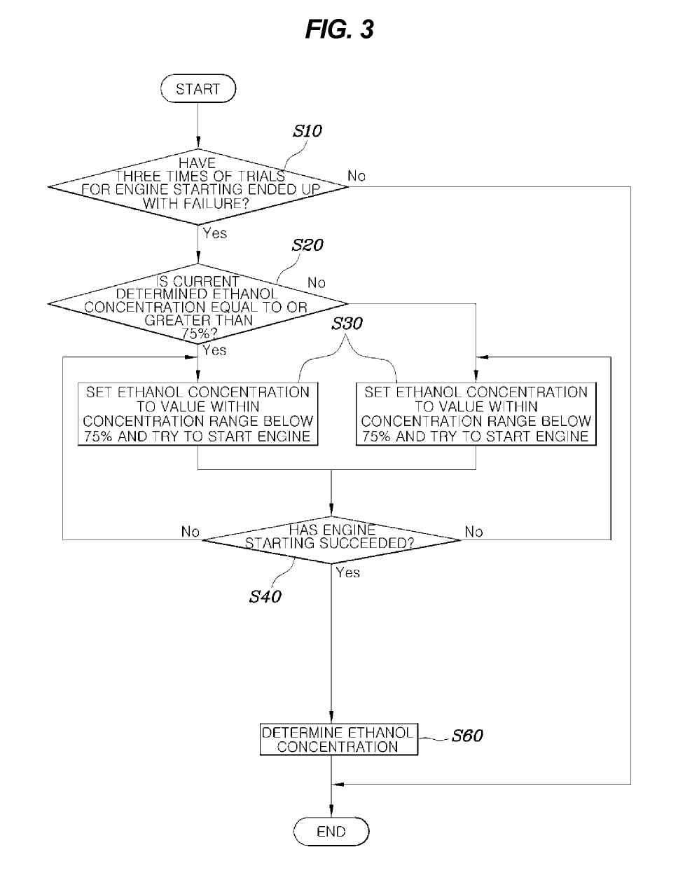

As illustrated in FIG. 3, the present invention may be implemented into another embodiment. Like the first embodiment, this embodiment includes an emergency situation determining step (S10), a reference determining step (S20), and a concentration swinging step (S30) which are sequentially performed, and then a starting success determining step (S40) is performed. After all through which, if the starting of the engine fails, the concentration swinging step (S30) may be repeatedly performed, rather than performing a concentration tracking step (S50).

In an upper value tracking step (S51) and a lower value tracking step (S52) of the concentration tracking step (S50), the value of the ethanol concentration is changed to alternate between an upper concentration range greater than a concentration reference value and a lower concentration range lower than the concentration reference value so as to determine the actual ethanol concentration. However, in those steps, even though the chance is low, if the value is changed to an erroneous concentration range in the first swing, the actual ethanol concentration cannot be properly estimated. Accordingly, the concentration swinging step (S30) is repeatedly performed so that the actual ethanol concentration can be tracked while changing the value as the candidate value of the actual ethanol concentration so that it alternates between the upper concentration range and the lower concentration range.

As a reference, after performing the concentration swinging step (S30), in addition to the above described two embodiments, an engine may be attempted to be started using the value of the ethanol concentration being changed in various patterns or by various control methods. During such control, the used values are examined via the starting success determining step (S40) so that the engine can be started.

In the emergency situation determining step (S10), when the number of cranking operations to start the engine is equal to or greater than a predetermined reference number which exceeds the number for smooth engine starting, for example, it is equal to or greater than three, it is determined that the engine needs to be started using an emergency starting method.

On the other hand, the starting success determining step (S40) determines that the engine starting has been successful, an ethanol concentration determining step (S60) of determining the concentration of ethanol is performed to determine a correct current ethanol concentration, and then the control ends.

For convenience in explanation and accurate definition in the appended claims, the terms upper or lower, front or rear, inside or outside, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method of controlling starting of an engine for an FFV, the method comprising:
an emergency situation determining step of determining whether an engine needs to be started using an emergency starting method;
a reference determining step of determining, when the emergency situation determining step determines that the engine needs to be started using an emergency starting method, whether a current determined ethanol concentration is equal to or greater than a predetermined concentration reference value;
a concentration swinging step of trying to start the engine, when the reference determining step determines that the current determined ethanol concentration is equal to or greater than the predetermined concentration reference value, using a value within a concentration range less than the predetermined concentration reference value as an ethanol concentration, but trying to start the engine, when the reference determining step determines that the current determined ethanol concentration is less than the predetermined concentration reference value, using a value within a concentration range greater than the predetermined concentration reference value; and
a starting success determining step of determining whether the starting of the engine has succeeded after performing the concentration swinging step.

2. The method of controlling starting of an engine for an FFV according to claim 1, further comprising:
a concentration tracking step of trying to start the engine, when the starting success determining step determines that the starting of the engine has failed, by changing the ethanol concentration to a value within a concentration range defined in the concentration swinging step.

3. The method of controlling starting of an engine for an FFV according to claim 2,
wherein the concentration tracking step includes an upper value tracking step of setting the ethanol concentration to a value within a concentration range greater than the predetermined concentration reference value and a lower value tracking step of setting the ethanol concentration to a value within a concentration range less than the predetermined concentration reference value, and
wherein in the lower value tracking step, the value of ethanol concentration is decreased by a relatively large amount at an early stage and then gradually decreased by a relatively smaller amount.

4. The method of controlling starting of an engine for an FFV according to claim 1,
wherein in the emergency situation determining step, when the number of cranking operations used to start the engine exceeds the number of cranking operations required in a case of smooth engine starting, it is determined that the engine needs to be started using the emergency starting method.

5. The method of controlling starting of an engine for an FFV according to claim 1, further comprising:
an ethanol concentration determining step of determining the ethanol concentration when the starting success determining step determines that the starting of the engine has succeeded.

6. The method of controlling starting of an engine for an FFV according to claim 1,
wherein when the starting success determining step determines that the starting of the engine has failed, the concentration swinging step is repeatedly performed.

7. A method of controlling starting of an engine for an FFV, the method comprising:
determining whether a cumulative number of cranking operations that have not led to a successful starting of an engine is greater than a predetermined number;
comparing, when trials of starting the engine have failed and the sum of the cranking operations has exceeded the predetermined reference value, a current determined ethanol concentration with a predetermined concentration reference value;
setting, when the current determined ethanol concentration is greater than the predetermined concentration reference value, an ethanol concentration to a value which is less than the predetermined concentration reference value, and then trying to start the engine; and
setting, when the current determined ethanol concentration is less than the predetermined concentration reference value, the ethanol concentration to a value which is greater than the predetermined concentration reference value, and then trying to start the engine.

8. The method of controlling starting of an engine for an FFV according to claim 7, further comprising:
determining whether the engine has successfully started after performing the setting and trying; and
determining the ethanol concentration and ending the control to start the engine.

9. The method of controlling starting of an engine for an FFV according to claim 7, further comprising:
when the setting and trying has not led to a successful start, using the ethanol concentration as the predetermined concentration reference value, resetting the ethanol concentration to a value, which is different from the value used in the setting and trying but which is within the same concentration range as the value used in the setting and trying, and then retrying to start the engine.

10. The method of controlling starting of an engine for an FFV according to claim 9,
wherein the using, resetting, and retrying is repeatedly performed while the value of the ethanol concentration is changed and set to a different value within the same concentration range until the engine has been successfully started.
